(19) United States
(12) Patent Application Publication
(10) Pub. No.: US 2018/0146114 A1
(43) Pub. Date: May 24, 2018

(54) ELECTRONIC APPARATUS

(71) Applicant: SEIKO EPSON CORPORATION, Tokyo (JP)

(72) Inventor: Susumu INOUE, Matsumoto (JP)

(21) Appl. No.: 15/784,530

(22) Filed: Oct. 16, 2017

(30) Foreign Application Priority Data
Nov. 18, 2016 (JP) 2016-224797

(51) Int. Cl. H04N 1/387; H04N 1/00; G06F 3/041; G06F 3/0488

(52) U.S. Cl. CPC H04N 1/3871; H04N 1/00408; G06F 3/0488; G06F 3/0416; G06F 3/0412

(57) ABSTRACT

An electronic apparatus includes a touch sensor that detects a touch position on an original document, and an image data editing section that edits an image on the original document based on the detected touch position.

### BACKGROUND

### 1. Technical Field

The present invention relates to an electronic apparatus that detects a touch position.

### 2. Related Art

There is known a multi-functional peripheral (MFP) including a display and a touch sensor. The touch sensor detects a touch position on the display (see JP-A-2015-026944).

In a case of an electronic apparatus including a detection section that detects a touch position on a display section as in the related-art MFP, the user performs a touch operation on the display section. When the screen size of the display section is small, a problem arises in that the user feels difficult to perform the touch operation.

### SUMMARY

An advantage of some aspects of the invention is that an electronic apparatus excellent in operability of touch operations is provided.

An electronic apparatus according to a first aspect of the invention includes a setting section on which an original document is set, an image data storing section that stores image data associated with an image shown in the original document, a detection section that detects a touch position on the setting section on which the original document is set, and an image data editing section that edits the stored image data at a position corresponding to the detected touch position on the setting section.

According to this configuration, the setting section on which the original document is set and the detection section are allowed to function as a touch panel. Therefore, the user can edit the image data by performing a touch operation on the original document set on the setting section. Thus, it is possible to provide an electronic apparatus excellent in operability of touch operations compared with a case where a touch operation is performed on a touch panel having a small screen size.

In this case, it is preferred that the electronic apparatus further include a display section that displays a print image based on the edited image data.

According to this configuration, the user can view the print image based on the edited image data.

In this case, it is preferred that the detection section further detect a touch position on the display section.

According to this configuration, the display section and the detection section are allowed to function as a touch panel.

In this case, it is preferred that the electronic apparatus further include a reading section that reads the image data from the original document, and that the image data storing section store the read image data.

According to this configuration, the image data can be stored by reading the image data from the original document by the reading section.

In this case, it is preferred that the electronic apparatus further include a transport section that transports the original document to a reading position of the reading section and then transports the original document to the setting section.

According to this configuration, it is possible to save time and effort for an operation of setting the original document on the setting section after the reading section has read the image data from the original document.

In this case, it is preferred that the setting section be provided with a reference mark indicating a setting position of the original document.

According to this configuration, by setting the original document in accordance with the reference mark, the user can set the original document at an appropriate position.

In this case, it is preferred that the electronic apparatus further include a printing section that performs printing based on the image data.

According to this configuration, the original document to be set on the setting section can be printed.

In this case, it is preferred that the electronic apparatus further include a printing section that performs printing based on the edited image data.

According to this configuration, the edited image data can be printed.

In this case, it is preferred that the electronic apparatus further include an image data transmitting section that transmits the edited image data.

According to this configuration, the edited image data can be transmitted.

In this case, it is preferred that the electronic apparatus further include a casing including a main body section and an operation section provided with the setting section and the detection section, and that the operation section be detachable from the main body section.

According to this configuration, by detaching the operation section from the main body section, the user can perform an operation on the original document set on the setting section of the operation section at a location different from the location where the main body section is installed.

An electronic apparatus according to a second aspect of the invention includes a setting section on which a print product having a plurality of options printed thereon is set, an option data storing section that stores option data in which an option and a touch range corresponding to a print range of the option are associated with each other for each of the options on the print product, a detection section that detects a touch position on the setting section on which the print product is set, and an option selecting section that selects an option associated with a touch range including the detected touch position on the setting section in the option data.

According to this configuration, the setting section on which the print product is set and the detection section are allowed to function as a touch panel. Therefore, the user can select an option by performing a touch operation on the print product set on the setting section. Thus, it is possible to provide an electronic apparatus excellent in operability of touch operations compared with the case where a touch operation is performed on a touch panel having a small screen size.

In this case, it is preferred that the electronic apparatus further include a display section that displays the selected option.

According to this configuration, the user can view the selected option.

In this case, it is preferred that the detection section further detect a touch position on the display section.

According to this configuration, the display section and the detection section are allowed to function as a touch panel.

In this case, it is preferred that the setting section be provided with a reference mark indicating a setting position of the print product.

According to this configuration, by setting the print product in accordance with the reference mark, the user can set the print product at an appropriate position.

In this case, it is preferred that the electronic apparatus further include a printing section that performs printing based on image data associated with the print product.

According to this configuration, the print product to be set on the setting section can be printed.

In this case, it is preferred that the electronic apparatus further include a printing section that performs printing based on image data associated with the selected option.

According to this configuration, the image data associated with the selected option can be printed.

In this case, it is preferred that the electronic apparatus further include a transmission destination data acquiring section that acquires transmission destination data associated with the selected option, and an image data transmitting section that transmits the image data based on the acquired transmission destination data.

According to this configuration, the image data can be transmitted to a transmission destination associated with the selected option.

An electronic apparatus according to a third aspect of the invention includes a setting section on which a print product having a plurality of operation targets printed thereon is set, an operation target data storing section that stores operation target data in which a control operation and a touch range corresponding to a print range of an operation target are associated with each other for each of the operation targets on the print product, a detection section that detects a touch position on the setting section on which the print product is set, and a control section that performs a control operation associated with a touch range including the detected touch position on the setting section in the operation target data.

According to this configuration, the setting section on which the print product is set and the detection section are allowed to function as a touch panel. Therefore, the user can cause the electronic apparatus to perform a desired control operation by performing a touch operation on the print product set on the setting section. Thus, it is possible to provide an electronic apparatus excellent in operability of touch operations compared with the case where a touch operation is performed on a touch panel having a small screen size.

In this case, it is preferred that the electronic apparatus further include a display section, and that the control section control the display section based on the operation target associated with the detected touch position on the setting section in the operation target data.

According to this configuration, displaying can be performed based on the operation target on which the touch operation is performed.

In this case, it is preferred that the detection section further detect a touch position on the display section.

According to this configuration, the display section and the detection section are allowed to function as a touch panel.

In this case, it is preferred that the setting section be provided with a reference mark indicating a setting position of the print product.

According to this configuration, by setting the print product in accordance with the reference mark, the user can set the print product at an appropriate position.

In this case, it is preferred that the electronic apparatus further include a printing section that performs printing based on image data associated with the print product.

According to this configuration, the print product to be set on the setting section can be printed.

### BRIEF DESCRIPTION OF THE DRAWINGS

The invention will be described with reference to the accompanying drawings, wherein like numbers reference like elements.

FIG. 1 is a diagram illustrating a multi-functional peripheral system including a multi-functional peripheral that is an electronic apparatus according to embodiments of the invention.

FIG. 2 is a diagram illustrating the schematic configuration of a multi-functional peripheral of a first embodiment.

FIG. 3 is a diagram illustrating the schematic configuration of an ADF.

FIG. 4 is a block diagram illustrating the overall configuration of the multi-functional peripheral of the first embodiment.

FIG. 5 is a flowchart of image editing processing to be executed by the multi-functional peripheral of the first embodiment.

FIG. 6 is a diagram illustrating an edit operation screen.

FIG. 7 is a diagram illustrating a state in which an original document is set on the multi-functional peripheral of the first embodiment.

FIG. 8 is a diagram illustrating a state in which a touch operation is performed on an edit button displayed on a display subsequently to FIG. 7.

FIG. 9 is a diagram illustrating a state in which a touch operation is performed on the original document set on a setting section subsequently to FIG. 8.

FIG. 10 is a diagram illustrating a state in which a preview screen is displayed on the display subsequently to FIG. 9.

FIG. 11 is a diagram illustrating an edited product printed based on edited image data subsequently to FIG. 10.

FIG. 12 is a diagram illustrating the schematic configuration of a multi-functional peripheral of a first modified example of the first embodiment.

FIG. 13 is a diagram illustrating the schematic configuration of a multi-functional peripheral of a second modified example of the first embodiment.

FIG. 14 is a diagram illustrating the schematic configuration of a scanner device of a third modified example of the first embodiment.

FIG. 15 is a diagram illustrating the schematic configuration of an operation device of a fourth modified example of the first embodiment.

FIG. 16 is a block diagram illustrating the overall configuration of a multi-functional peripheral of a second embodiment.

FIG. 17 is a flowchart of option selecting processing to be executed by the multi-functional peripheral of the second embodiment.

FIG. 18 is a diagram illustrating a state in which a print product is set on the multi-functional peripheral of the second embodiment.

FIG. 19 is a diagram illustrating a state in which a touch operation is performed on a thumbnail printed on the print product subsequently to FIG. 18.

FIG. 20 is a diagram illustrating a state in which the selected thumbnail is displayed on a display subsequently to FIG. 19.

FIG. 21 is a diagram illustrating a photograph printed in association with the selected thumbnail subsequently to FIG. 20.

FIG. 22 is a block diagram illustrating the overall configuration of a multi-functional peripheral of a modified example of the second embodiment.

FIG. 23 is a flowchart of option selecting processing to be executed by the multi-functional peripheral of the modified example of the second embodiment.

FIG. 24 is a diagram illustrating a state in which a print product is set on the multi-functional peripheral of the modified example of the second embodiment.

FIG. 25 is a diagram illustrating a state in which a touch operation is performed on a facsimile transmission destination printed on the print product subsequently to FIG. 24.

FIG. 26 is a diagram illustrating a state in which the selected facsimile transmission destination is displayed on the display subsequently to FIG. 25.

FIG. 27 is a block diagram illustrating the overall configuration of a multi-functional peripheral of a third embodiment.

FIG. 28 is a flowchart of operation control processing to be executed by the multi-functional peripheral of the third embodiment.

FIG. 29 is a diagram illustrating a state in which a print product is set on the multi-functional peripheral of the third embodiment.

FIG. 30 is a diagram illustrating a state in which a touch operation is performed on a key printed on the print product subsequently to FIG. 29.

FIG. 31 is a diagram illustrating a state in which an image associated with the key on which the touch operation is performed is displayed on a display subsequently to FIG. 30.

FIG. 32 is a diagram illustrating another example of the print product.

### DESCRIPTION OF EXEMPLARY EMBODIMENTS

A multi-functional peripheral 1 that is an electronic apparatus according to a first embodiment of the invention is described. The multi-functional peripheral 1 has a plurality of functions such as printing, scanning, copying, facsimile communication, and email sending functions. The multi-functional peripheral 1 of the first embodiment is configured to execute image editing processing that involves detecting a touch position on a setting section 12 on which an original document D1 is set and editing image data associated with the original document D1 based on the detected touch position.

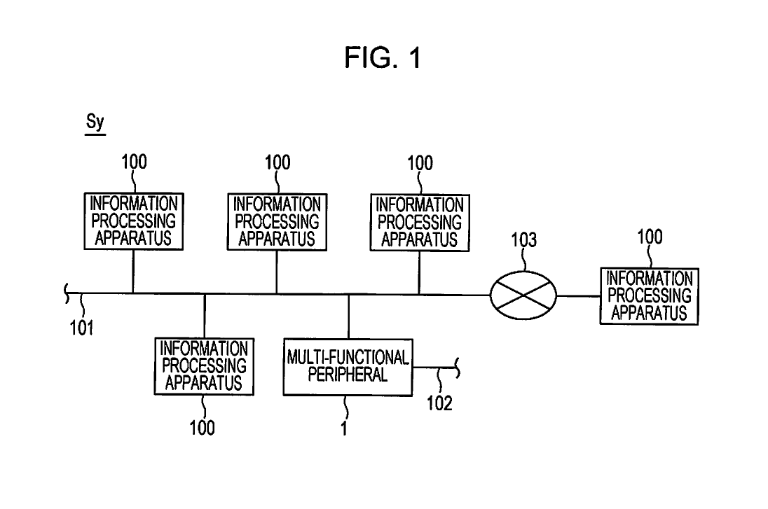

A multi-functional peripheral system Sy including the multi-functional peripheral 1 is described with reference to FIG. 1. The multi-functional peripheral 1 is connected to a local area network (LAN) 101 and a telephone line 102. Information processing apparatuses 100 are connected to the LAN 101. For example, a personal computer, a file server, or a mail server may be used as the information processing apparatus 100. The multi-functional peripheral 1 is communicable with the information processing apparatuses 100 via the LAN 101. The LAN 101 is connected to the Internet 103. The multi-functional peripheral 1 is communicable with an information processing apparatus 100 (for example, a cloud server) provided on the Internet 103 via the LAN 101 and the Internet 103. The multi-functional peripheral 1 is capable of performing facsimile communication by using the telephone line 102.

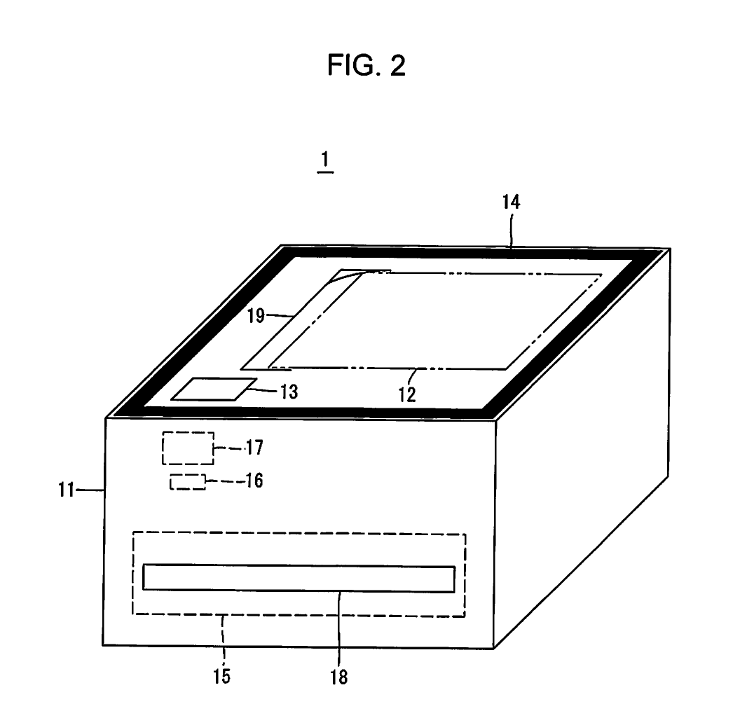

The schematic configuration of the multi-functional peripheral 1 is described with reference to FIG. 2. The multi-functional peripheral 1 includes a casing 11, the setting section 12, a display 13, a touch sensor 14, a printing mechanism 15, a reading unit 16, and an auto document feeder (ADF) 17. The setting section 12, the display 13, and the touch sensor 14 are provided on the top surface of the casing 11 having a substantially rectangular parallelepiped shape. The printing mechanism 15, the reading unit 16, and the ADF 17 are built in the casing 11. A discharge port 18 through which a printing medium is discharged after printing has been performed is provided on one side surface of the casing 11.

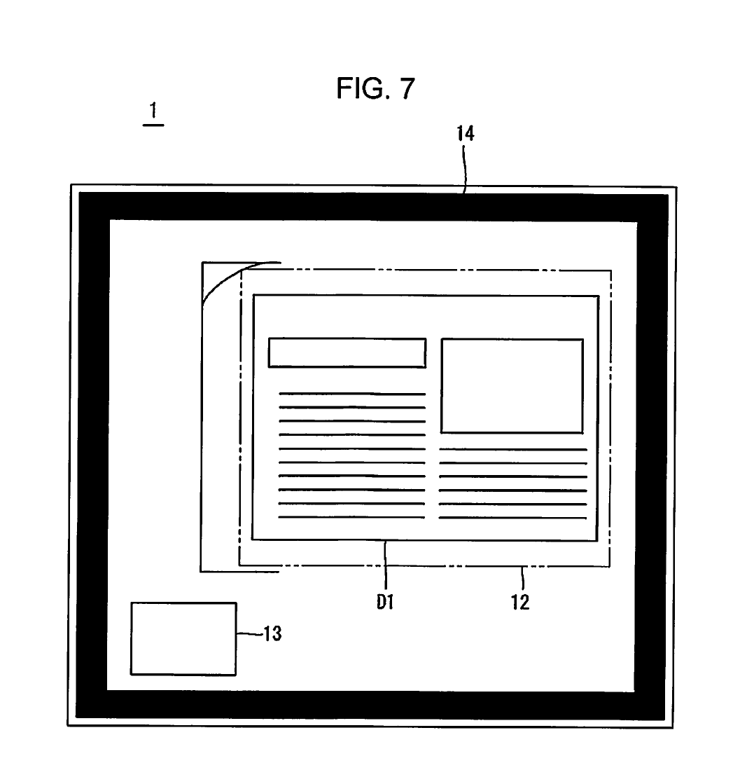

The original document D1 (see FIG. 7) is set on the setting section 12. Printed or hand-drawn images are shown in the original document D1. The display 13 performs various kinds of displaying. For example, a liquid crystal display or an organic electroluminescence (EL) display may be used as the display 13. The screen size of the display 13 is not particularly limited and is smaller (for example, the length of the diagonal line is about three inches) than a normal size (for example, A4 size) of the original document D1 to be set on the setting section 12.

The touch sensor 14 is provided in a frame-like shape above the top surface (touch surface) of the casing 11 along four sides of the touch surface. Specifically, the touch sensor 14 is an optical touch sensor in which a light emitting section that emits detection light (for example, infrared rays) and a light receiving section that faces the light emitting section and receives the detection light are provided in vertical/horizontal directions. The frame provided above the top surface may include a light guide member alone and an LED serving as a light source and a photoelectric conversion element may be provided inside the casing 11 below the top surface. In this case, light generated by the LED inside the casing 11 passes through the light guide member and is output from the light emitting section of the light guide member. Then, the light passes over the touch surface, enters the light receiving section of the light guide member, passes through the light guide member, and reaches the photoelectric conversion element inside the casing 11. The photoelectric conversion element converts the light into an electric signal. When a user tries to touch the touch surface with their finger or a touch pen, the finger or the touch pen blocks the light passing over the touch surface. In this manner, the touch can be detected based on an output from the photoelectric conversion element. The touch surface may be provided on a surface other than the top surface of the casing as long as the touch surface is oriented upward. The touch sensor 14 may include two light emitting sections and an image sensor that receives detection light, thereby detecting a touch position through triangulation. Further, the touch sensor 14 is not limited to the optical touch sensor and may be other types of touch sensor such as a capacitive touch sensor and a resistive touch sensor.

When the casing 11 is viewed from the top, the setting section 12 and the display 13 are provided on the inner side of the touch sensor 14, that is, in a range in which the touch sensor 14 can detect a touch position. Therefore, the touch sensor 14 can detect a touch position on the setting section 12 and a touch position on the display 13. Thus, the setting section 12 on which the original document D1 is set and the touch sensor 14 are allowed to function as a touch panel. Further, the display 13 and the touch sensor 14 are allowed to function as a touch panel. In other words, a region where the display 13 is not provided can also be used as a touch panel by providing the touch sensor 14 having a detectable region which is larger than the screen size of the display 13. For example, the touch position is detected as coordinate data in the detectable region of the touch sensor 14.

When there is no need to detect a touch position on the display 13, the touch sensor 14 may detect a touch position on the setting section 12 alone. Specifically, the setting section 12 may be provided inside the detectable region of the touch sensor 14, while the display 13 is provided outside the detectable region of the touch sensor 14. The detection region for a touch position may be switchable between the setting section 12 alone, the display 13 in addition to the setting section 12, and other regions by providing modes or the like. This configuration can be achieved by, for example, stopping light emission outside the detection region for a touch position.

The printing mechanism 15 performs printing on a printing medium such as printing paper based on, for example, image data read by the reading unit 16. The printing system of the printing mechanism 15 is not particularly limited and may be, for example, an ink jet system or an electrophotographic system.

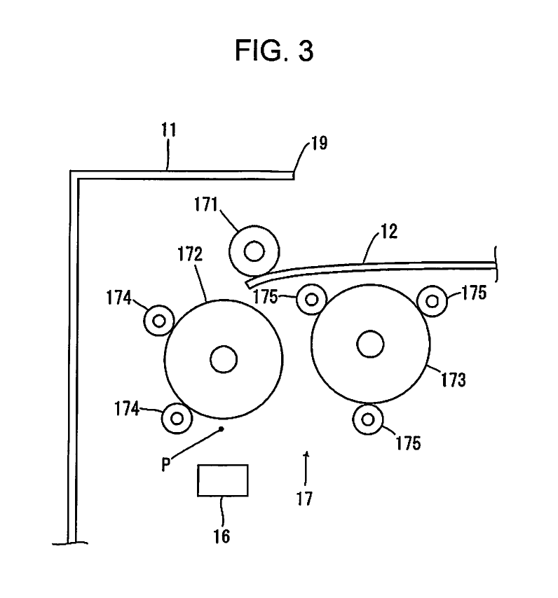

The reading unit 16 reads image data from the original document D1 transported to a reading position P (see FIG. 3) of the reading unit 16 by the ADF 17. Although illustration is omitted, the reading unit 16 includes a light source and an image sensor. The light source radiates light to the original document D1 passing over the reading position P. The image sensor detects the light reflected from the original document D1 passing over the reading position P.

The ADF 17 transports the original document D1 set on the setting section 12 toward the reading position P of the reading unit 16. After the original document D1 has been transported to the reading position P, the ADF 17 transports the original document D1 to the setting section 12. Thus, the original document D1 is set on the setting section 12. Specifically, the original document D1 is set at a predetermined position in the detectable region of the touch sensor 14. Therefore, it is possible to save time and effort for an operation of setting the original document D1 on the setting section 12 after the reading unit 16 has read image data from the original document D1. A transport port 19 that is an access port to a transport path of the original document D1 is provided on the top surface of the casing 11.

The ADF 17 is described with reference to FIG. 3. The ADF 17 includes a feed roller 171, a transport roller 172, and a reverse roller 173. The feed roller 171 is provided near the transport port 19 and transports the original document D1 set on the setting section 12 toward the transport roller 172. The transport roller 172 is provided so as to face the reading unit 16 and transports the original document D1 transported from the feed roller 171 toward the reverse roller 173 so that the original document D1 passes over the reading position P. The reverse roller 173 transports the original document D1 so that the original document D1 passes around the reverse roller 173, thereby reversing the original document D1. A plurality of transport guide rollers 174 are provided around the transport roller 172 and a plurality of reverse guide rollers 175 are provided around the reverse roller 173.

When the reading unit 16 reads only one side of the original document D1, the original document D1 set on the setting section 12 is transported toward the reverse roller 173 via the transport roller 172 to pass over the reading position P. At this time, the reading unit 16 reads one of the two sides of the original document D1 which has been oriented upward while being set on the setting section 12. When the entire original document D1 has passed over the reading position P, the original document D1 is transported toward the setting section 12. Thus, the original document D1 is automatically set on the setting section 12 so that the side which has been oriented upward while being set on the setting section 12 before the transport, that is, the reading side is oriented upward.

When the reading unit 16 reads both sides of the original document D1, the original document D1 is first transported similarly to the case where only one side is read. Thus, the reading unit 16 reads the side which has been oriented upward while being set on the setting section 12. After the original document D1 is reversed by being transported around the reverse roller 173, the original document D1 is transported toward the setting section 12. When the entire original document D1 is transported to the setting section 12 side of the reading position P, the original document D1 is transported toward the reverse roller 173 again to pass over the reading position P. At this time, the reading unit 16 reads one of the two sides of the original document D1 which is opposite the previous reading side, that is, the side which has been oriented downward while being set on the setting section 12. After the original document D1 is reversed by being transported around the reverse roller 173, the original document D1 is transported toward the setting section 12. Thus, the original document D1 is automatically set on the setting section 12 so that the side which has been oriented upward while being set on the setting section 12 before the transport, that is, the first reading side is oriented upward. The ADF 17 may transport the original document D1 to the setting section 12 so that the second reading side is oriented upward. Further, the ADF 17 may transport the original document D1 so that only one side can be read.

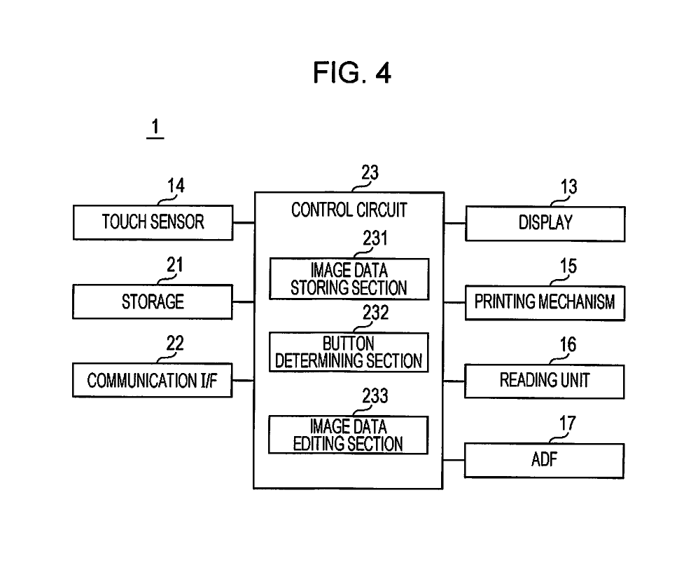

The overall configuration of the multi-functional peripheral 1 is described with reference to FIG. 4. The multi-functional peripheral 1 further includes a storage 21, a communication interface 22, and a control circuit 23 in addition to the display 13, the touch sensor 14, the printing mechanism 15, the reading unit 16, and the ADF 17.

The storage 21 stores various kinds of data. For example, a hard disk drive may be used as the storage 21. The communication interface 22 transmits/receives various kinds of command and data to/from an external apparatus such as the information processing apparatus 100.

The control circuit 23 includes an image data storing section 231, a button determining section 232, and an image data editing section 233 as functional sections. Although illustration is omitted, the control circuit 23 includes a processor (a central processing unit (CPU), an application specific integrated circuit (ASIC), or a combination thereof, which may be constituted by a single chip or a plurality of chips), a read only memory (ROM), and a random access memory (RAM). The CPU executes programs stored in the ROM by using the RAM, thereby achieving the respective functional sections of the control circuit 23, that is, the image data storing section 231, the button determining section 232, and the image data editing section 233. The same applies to respective functional sections of second and third embodiments described later.

The image data storing section 231 stores image data. For example, the image data is read from the original document D1 by the reading unit 16.

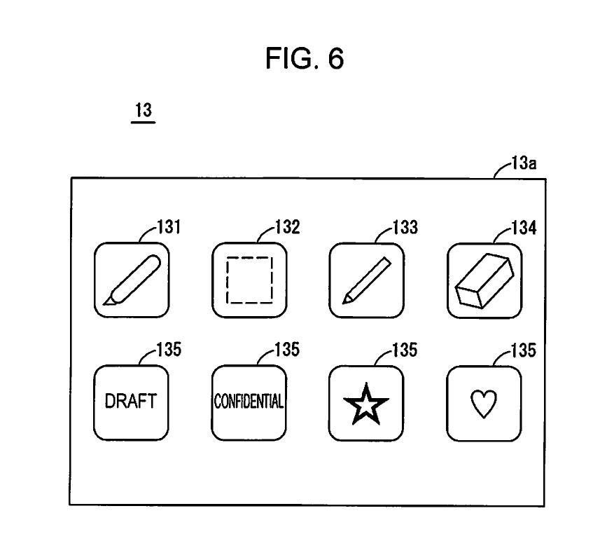

The button determining section 232 determines, based on a touch position on the display 13 which is detected by the touch sensor 14, an edit button selected through a user's touch operation from among edit buttons displayed on an edit operation screen 13a (see FIG. 6) of the display 13 described later.

The image data editing section 233 edits the image data stored in the image data storing section 231 at a position corresponding to the touch position on the setting section 12 which is detected by the touch sensor 14.

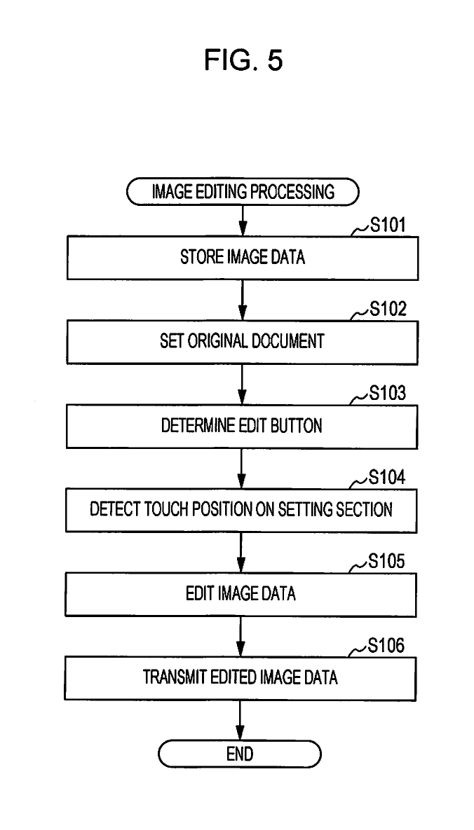

The image editing processing to be executed by the multi-functional peripheral 1 is described with reference to FIG. 5 and also to FIG. 4.

In Step S101, the user first sets the original document D1 on the setting section 12. The original document D1 to be set on the setting section 12 may be printed by a different apparatus or drawn freehand. Further, the original document D1 may be printed by the multi-functional peripheral 1 itself based on image data read out from the storage 21 or transmitted from the information processing apparatus 100.

When a predetermined touch operation is performed on the display 13 with the original document D1 set on the setting section 12, the ADF 17 starts to transport the original document D1 set on the setting section 12. Then, the reading unit 16 reads image data from the original document D1 passing over the reading position P. The image data storing section 231 stores the read image data.

In Step S102, the ADF 17 transports the original document D1 that has passed over the reading position P to the setting section 12. Thus, the original document D1 is set on the setting section 12.

In Step S103, the display 13 displays the edit operation screen 13a and the button determining section 232 determines an edit button selected through a user's touch operation from among a plurality of edit buttons displayed on the edit operation screen 13a.

As illustrated in FIG. 6, a plurality of edit buttons such as a marker button 131, a trimming button 132, a pencil button 133, an eraser button 134, and stamp buttons 135 are displayed on the edit operation screen 13a. The marker button 131 is an edit button for marking a desired character string. The trimming button 132 is an edit button for trimming a desired region. The pencil button 133 is an edit button for handwriting input. The eraser button 134 is an edit button for erasing, for example, characters input by handwriting using the pencil button 133. The stamp button 135 is an edit button for adding a predetermined character string (for example, “DRAFT”), picture (for example, a star mark), or the like. As a matter of course, the number and types of edit buttons to be displayed on the edit operation screen 13a are not limited to those described above.

When the user performs a touch operation on a desired edit button out of the plurality of edit buttons displayed on the edit operation screen 13a, the touch sensor 14 detects a touch position on the display 13. Then, the button determining section 232 determines the edit button selected through the touch operation based on the detected touch position on the display 13.

Referring back to FIG. 5, in Step S104, when the user performs a touch operation associated with the selected edit button at a desired position on the original document D1, the touch sensor 14 detects a touch position on the setting section 12.

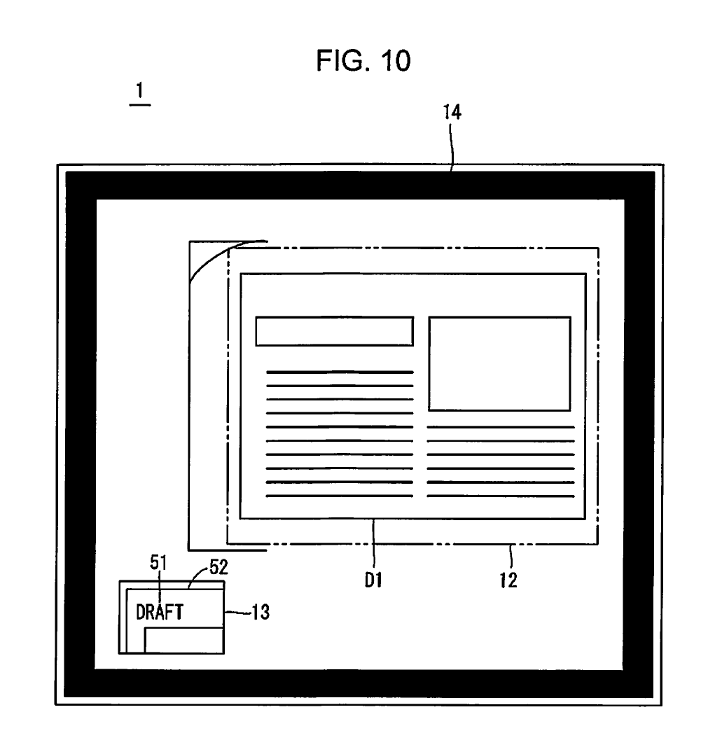

In Step S105, the image data editing section 233 edits the image data stored in the image data storing section 231 at a position corresponding to the detected touch position on the setting section 12 in association with the edit button determined by the button determining section 232. Then, the display 13 displays a print image 52 (see FIG. 10) based on the edited image data. Thus, the user can view the print image 52 based on the edited image data.

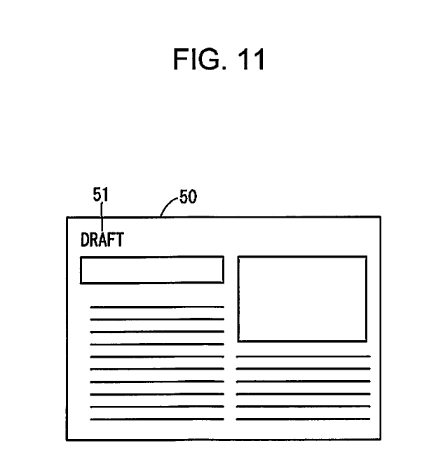

In Step S106, when the user views the print image 52 displayed on the display 13 and performs a predetermined touch operation on the display 13, the communication interface 22 transmits the edited image data by facsimile to a transmission destination designated by the user. Thus, a facsimile apparatus at the transmission destination performs printing based on the image data transmitted from the multi-functional peripheral 1. As a result, an edited product 50 (see FIG. 11) obtained by editing the original document D1 is printed. The communication interface 22 may transmit the edited image data by email.

In Step S101, image data may be read from the original document D1 by the reading unit 16 and stored in the storage 21 in advance. The image data storing section 231 may store the image data by reading out the image data from the storage 21. Further, the image data storing section 231 may store image data transmitted from the information processing apparatus 100. In those cases, the user sets, on the setting section 12, an original document D1 printed by the multi-functional peripheral 1 based on the image data stored in the image data storing section 231 or an original document D1 printed by a different apparatus based on the same image data as the stored image data. Then, the processing proceeds to Step S103.

In Step S106, the printing mechanism 15 may perform printing based on the edited image data. Thus, the multi-functional peripheral 1 itself can print the edited image data.

Referring to FIG. 7 to FIG. 11, an operation procedure in a case of transmitting image data which is edited so that a stamp 51 (see FIG. 11) is affixed to the original document D1 is described as an example of the use of the multi-functional peripheral 1.

First, the user sets the original document D1 on the setting section 12 as illustrated in FIG. 7. When the user performs a predetermined operation on the display 13, the original document D1 set on the setting section 12 is transported. After image data has been read from the original document D1, the original document D1 is set on the setting section 12 again.

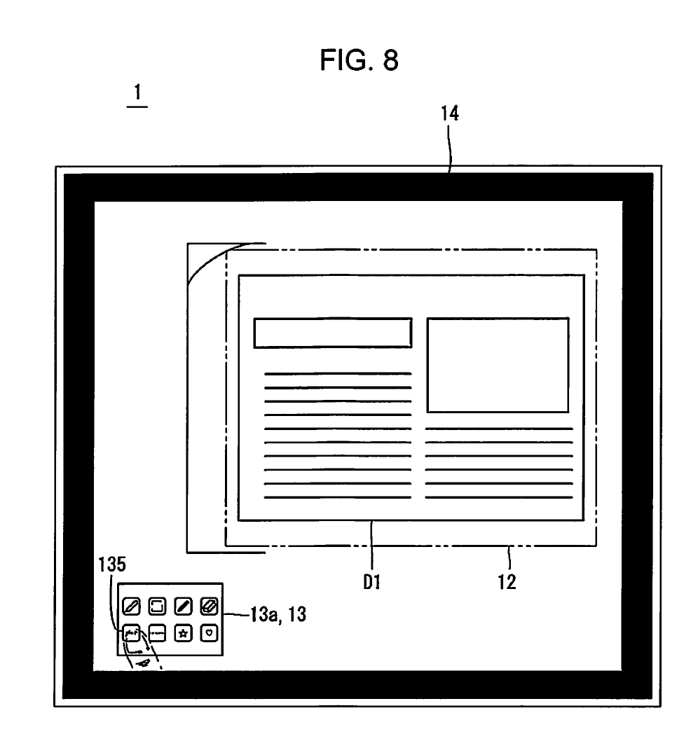

Then, as illustrated in FIG. 8, the user performs a touch operation on a desired edit button (in this case, the stamp button 135) out of the plurality of edit buttons displayed on the edit operation screen 13a.

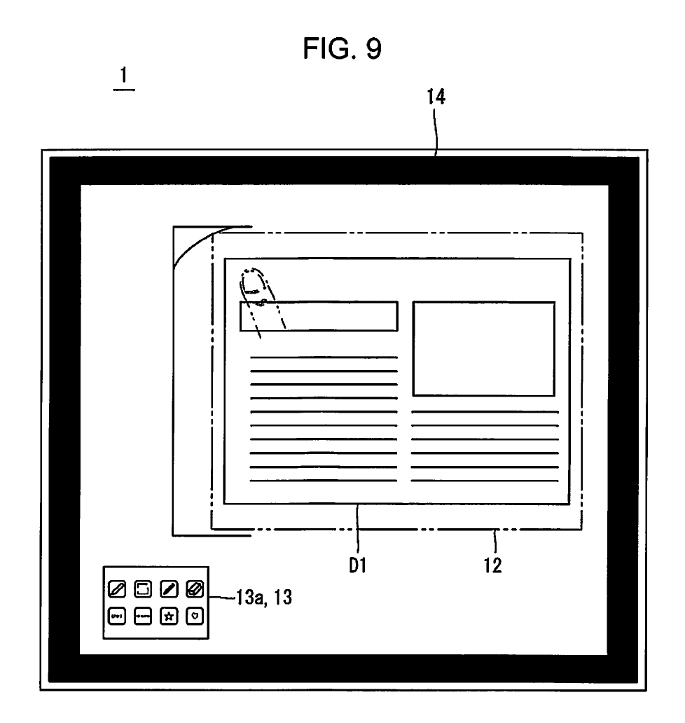

Then, as illustrated in FIG. 9, the user performs a touch operation on the original document D1 set on the setting section 12 at a position where the user desires to affix the stamp 51. At this time, the touch sensor 14 detects a touch position on the setting section 12 and the image data is edited so that the stamp 51 is affixed to a position corresponding to the detected touch position. As a result, as illustrated in FIG. 10, the display 13 displays the print image 52 having the stamp 51 affixed to a position where the touch operation is performed on the original document D1.

When the user views the print image 52 displayed on the display 13 and performs a predetermined operation on the display 13, the edited image data is transmitted to a facsimile apparatus at a transmission destination designated by the user. Then, as illustrated in FIG. 11, the facsimile apparatus at the transmission destination prints the edited product 50 obtained by affixing the stamp 51 to the original document D1.

As described above, the multi-functional peripheral 1 of the first embodiment includes the setting section 12, the image data storing section 231, the touch sensor 14, and the image data editing section 233. The original document D1 is set on the setting section 12. The image data storing section 231 stores image data associated with an image shown in the original document D1. The touch sensor 14 detects a touch position on the setting section 12 on which the original document D1 is set. The image data editing section 233 edits the stored image data at a position corresponding to the detected touch position on the setting section 12.

According to this configuration, the setting section 12 on which the original document D1 is set and the touch sensor 14 are allowed to function as a touch panel. Therefore, the user can edit the image data by performing a touch operation on the original document D1 set on the setting section 12. Thus, it is possible to provide a multi-functional peripheral 1 excellent in operability of touch operations compared with a case where a touch operation is performed on a touch panel having a small screen size. In other words, the user's touch on the original document D1 set on the setting section 12 triggers an operation. Therefore, the user can intuitively perform a touch operation on the original document D1 that shows the entire image in its original size without partial or reduced image display unlike the case of a touch panel having a small screen size.

Modified examples of the first embodiment are described. In each modified example and the second and third embodiments described later, description of similar points to those of the embodiments which have already been described is omitted as appropriate and differences from the embodiments which have already been described are mainly described.

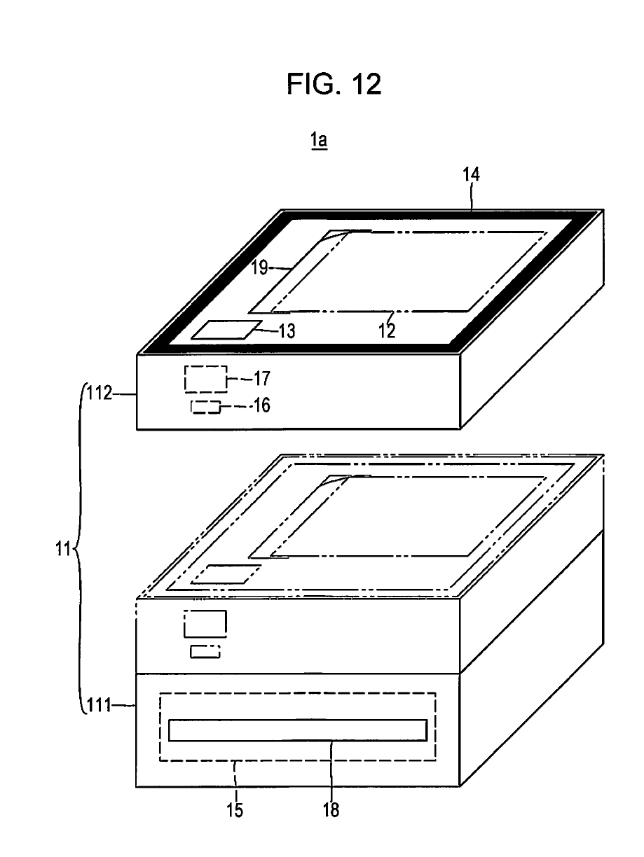

A multi-functional peripheral 1a that is a first modified example of the first embodiment is described with reference to FIG. 12. In the multi-functional peripheral 1a, the casing 11 includes a main body section 111 and an operation section 112. The operation section 112 is detachably provided on the top surface of the main body section 111. The main body section 111 is provided with the printing mechanism 15 and the operation section 112 is provided with components other than the printing mechanism 15, but the configuration is not limited thereto. It is only necessary that the operation section 112 be at least provided with the setting section 12, the touch sensor 14, and the control circuit 23. Although specific illustration is omitted, the multi-functional peripheral 1a includes the communication interface 22 and the control circuit 23 similarly to the multi-functional peripheral 1. The same applies to a multi-functional peripheral 1b, a scanner device 1c, and an operation device 1d that are described later.

According to the multi-functional peripheral 1a constructed as described above, by detaching the operation section 112 from the main body section 111, the user can perform an operation on the original document D1 set on the setting section 12 of the operation section 112 at a location different from the location where the main body section 111 is installed.

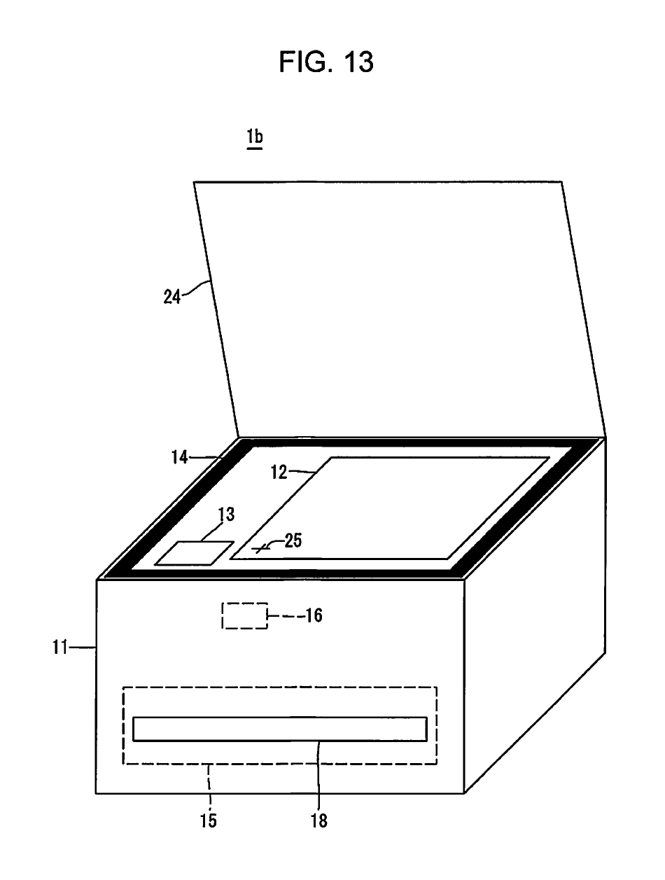

The multi-functional peripheral 1b that is a second modified example of the first embodiment is described with reference to FIG. 13. The multi-functional peripheral 1b includes a flatbed-type reading unit 16 but does not include the ADF 17. Further, the multi-functional peripheral 1b includes a cover 24 provided at one end of the top surface of the casing 11 in an openable/closable manner.

The cover 24 is provided at one end of the top surface of the casing 11 in an openable/closable manner. Similarly to the case of the multi-functional peripheral 1, the frame-like touch sensor 14 is provided on the top surface of the casing 11 and the setting section 12 and the display 13 are provided in the detectable region of the touch sensor 14.

The setting section 12 is formed of a light-transmissive material (for example, glass) into a plate shape. The setting section 12 is provided with a reference mark 25 indicating a setting position of the original document D1. By setting the original document D1 in accordance with the reference mark 25, the user can set the original document D1 at an appropriate position.

Although illustration is omitted, the reading unit 16 includes a light source, an image sensor, and a moving mechanism. The light source is provided below the setting section 12 and radiates light to the original document D1 via the setting section 12. The image sensor is provided below the setting section 12 and detects the light reflected from the original document D1 set on the setting section 12. The moving mechanism moves the light source and the image sensor in a direction parallel to the top surface of the setting section 12.

In the multi-functional peripheral 1b, the user first opens the cover 24 and sets the original document D1 at the position indicated by the reference mark 25 with the reading side oriented downward. Then, the user closes the cover 24 and the reading unit 16 reads image data from the original document D1. The image data storing section 231 stores the read image data. Then, the user opens the cover 24 again and sets the original document D1 at the position indicated by the reference mark 25 with the reading side oriented upward by reversing the original document D1. Then, similarly to the case of the multi-functional peripheral 1, the touch sensor 14 detects a touch position on the setting section 12 on which the original document D1 is set and the image data editing section 233 edits the image data stored in the image data storing section 231 at a position corresponding to the detected touch position on the setting section 12.

The setting position of the original document D1 may differ between the case where the reading unit 16 reads image data from the original document D1 and the case where the touch sensor 14 detects a touch position on the setting section 12 on which the original document D1 is set. Therefore, a reference mark 25 indicating the setting position of the original document D1 at the time of reading and a reference mark 25 indicating the setting position of the original document D1 at the time of touch position detection may be provided separately.

The reading unit 16 may be provided on the cover 24 side instead of the casing 11 side. In this case, the original document D1 is set on the setting section 12 before the reading with the reading side oriented upward. Therefore, the user can perform a touch operation on the original document D1 without reversing the original document D1 after the reading.

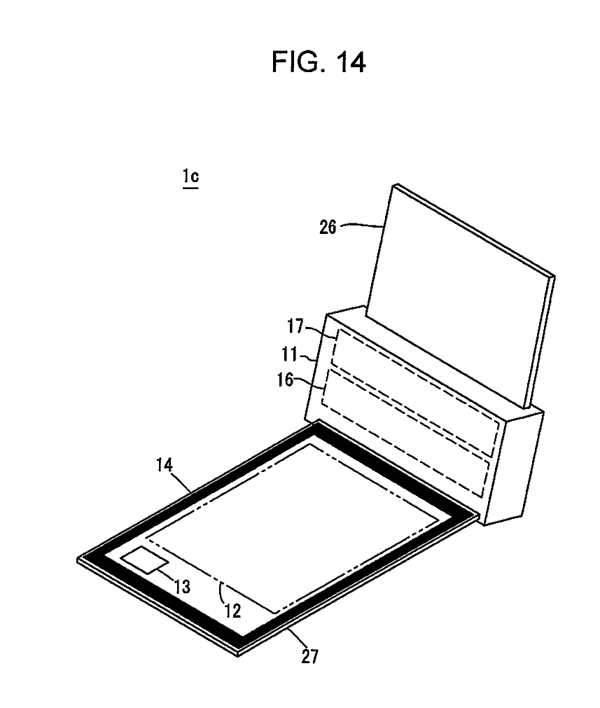

The scanner device 1c that is a third modified example of the first embodiment is described with reference to FIG. 14.

The scanner device 1c includes the casing 11, a feed tray 26, a discharge tray 27, the setting section 12, the display 13, the touch sensor 14, the reading unit 16, and the ADF 17.

The original document D1 is set on the feed tray 26. The original document D1 transported from the feed tray 26 is discharged onto the discharge tray 27. Similarly to the case of the multi-functional peripheral 1, the frame-like touch sensor 14 is provided on the top surface of the discharge tray 27 and the setting section 12 and the display 13 are provided in the detectable region of the touch sensor 14.

In the scanner device 1c, the ADF 17 transports the original document D1 set on the feed tray 26. After the original document D1 has passed through the casing 11 and the reading unit 16 has read image data, the original document D1 is discharged onto the discharge tray 27. Thus, the original document D1 is automatically set on the setting section 12 provided on the discharge tray 27 so that the reading side is oriented upward. Then, similarly to the case of the multi-functional peripheral 1, the touch sensor 14 detects a touch position on the setting section 12 on which the original document D1 is set and the image data editing section 233 edits the image data stored in the image data storing section 231 at a position corresponding to the detected touch position on the setting section 12. The edited image data is transmitted to an external apparatus such as a personal computer that is communicably connected to the scanner device 1c.

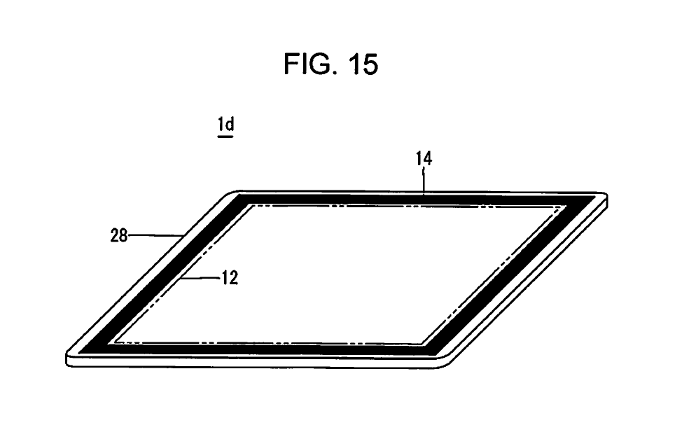

The operation device 1d that is a fourth modified example of the first embodiment is described with reference to FIG. 15. The operation device 1d includes an operation sheet 28, the setting section 12, and the touch sensor 14. The setting section 12, the touch sensor 14, and an edit operation section (not illustrated) are provided on one surface of the operation sheet 28. The operation sheet 28 may have flexibility. In this case, the operation device 1d can be rolled when being stored or carried.

In the operation device 1d, an edit operation screen serving as the edit operation section is displayed in at least a part of the area of the operation sheet 28. On the edit operation screen, an edit button is selected through a user's touch operation and the user sets the original document D1 on the setting section 12. Then, similarly to the case of the multi-functional peripheral 1, the touch sensor 14 detects a touch position on the setting section 12 on which the original document D1 is set and the image data editing section 233 edits image data stored in the image data storing section 231 at a position corresponding to the detected touch position on the setting section 12. The edited image data is transmitted to an external apparatus such as a smartphone that is communicably connected to the operation device 1d. The discharge tray 27 of the scanner device is may be replaced with the operation device 1d. In this case, the discharge tray 27 serving as the operation device 1d may be connected to the scanner device 1c by a USB cable or the like.

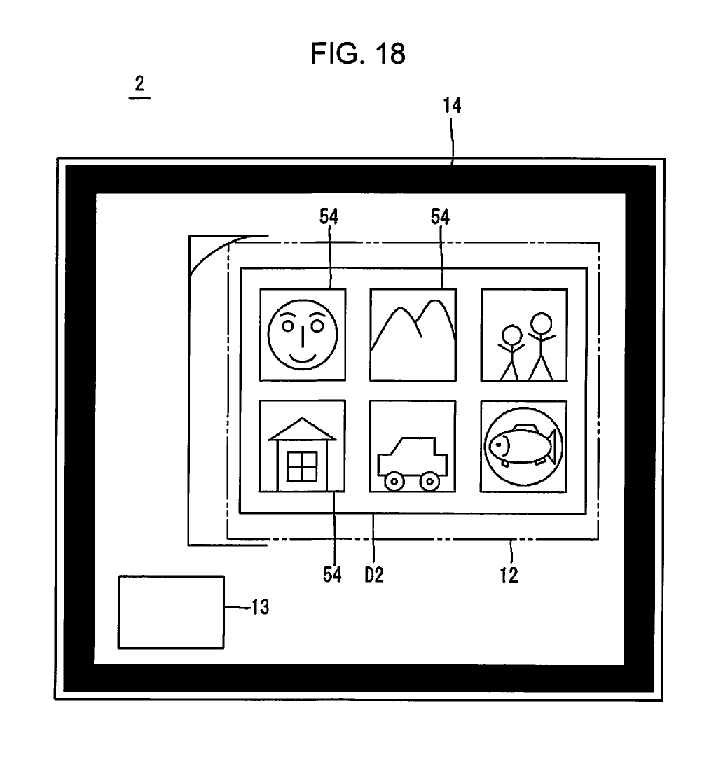

A multi-functional peripheral 2 that is an electronic apparatus according to the second embodiment of the invention is described. The multi-functional peripheral 2 of the second embodiment is configured to execute option selecting processing that involves detecting a touch position on the setting section 12 on which a print product D2 (see FIG. 18) having a plurality of options printed thereon in association with a plurality of pieces of image data is set and selecting an option based on the detected touch position. The modified examples and other examples described in the first embodiment are similarly applicable to the second and other subsequent embodiments.

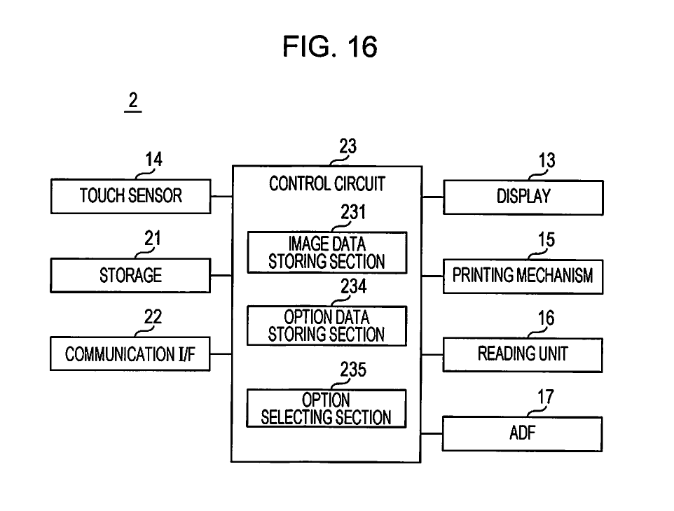

The overall configuration of the multi-functional peripheral 2 is described with reference to FIG. 16. In the multi-functional peripheral 2, the control circuit 23 includes the image data storing section 231, an option data storing section 234, and an option selecting section 235 as functional sections.

The option data storing section 234 stores option data. The option data refers to data in which an option and a touch range corresponding to a print range of the option are associated with each other for each of the plurality of options printed on the print product D2. For example, the touch range is represented as coordinate data in the detectable region of the touch sensor 14.

The option selecting section 235 selects an option associated with a touch range including a detected touch position on the setting section 12 in the option data.

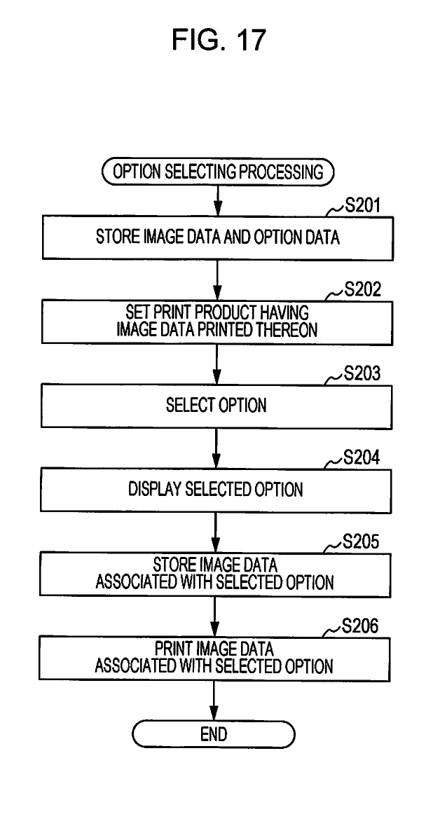

The option selecting processing to be executed by the multi-functional peripheral 2 is described with reference to FIG. 17 and also to FIG. 16.

In Step S201, the information processing apparatus 100 transmits a print job for the print product D2 to the multi-functional peripheral 2 and the multi-functional peripheral 2 receives the print job. The print job includes image data and option data associated with the print product D2. The image data storing section 231 stores the image data and the option data storing/section 234 stores the option data. Then, the printing mechanism 15 performs printing based on the image data, thereby creating the print product D2 having a plurality of options printed thereon.

In Step S202, the user sets the print product D2 printed in Step S201 on the setting section 12.

In Step S203, when the user performs a touch operation on the print product D2 set on the setting section 12 so as to select a desired option from among the plurality of options, the touch sensor 14 detects a touch position on the setting section 12 on which the print product D2 is set. Then, the option selecting section 235 refers to the option data stored in the option data storing section 234 and selects an option associated with a touch range including the detected touch position on the setting section 12 in the option data. When the touch sensor 14 detects a touch position on the setting section 12 again after one option is selected, the option selecting section 235 may select an option associated with a touch range including the touch position in place of or in addition to the option which has been selected first.

In Step S204, the display 13 displays the option selected by the option selecting section 235. Thus, the user can view the selected option. At this time, the display 13 may display the selected option together with the other options in such a manner that the selected option can be distinguished from the other options. Alternatively, the display 13 may display the selected option alone.

In Step S205, when the user views the option displayed on the display 13 and performs a predetermined touch operation on the display 13, the multi-functional peripheral 2 requests the information processing apparatus 100 to transmit image data associated with the selected option. Then, the information processing apparatus 100 transmits the requested image data to the multi-functional peripheral 2 and the multi-functional peripheral 2 receives the image data. Thus, the image data storing section 231 stores the image data associated with the selected option.

In Step S206, the printing mechanism 15 performs printing based on the image data stored in the image data storing section 231, that is, the image data associated with the option selected in Step S203.

In Step S202, a print product D2 printed by a different apparatus may be set on the setting section 12 in place of the print product D2 printed by the multi-functional peripheral 2. In this case, it is only necessary in Step S201 that the option data storing section 234 store option data associated with the print product D2 printed by the different apparatus. It is unnecessary that the image data storing section 231 store image data and the printing mechanism 15 perform printing based on the stored image data.

In Step S205, the image data storing section 231 may store image data read out from the storage 21 in association with the selected option instead of storing the image data transmitted from the information processing apparatus 100 in association with the selected option.

Referring to FIG. 18 to FIG. 21, an operation procedure in a case of printing a desired photograph 53 by using the print product D2 (photograph index) having a plurality of thumbnails 54 printed thereon in association with a plurality of photographs 53 is described as an example of the use of the multi-functional peripheral 2.

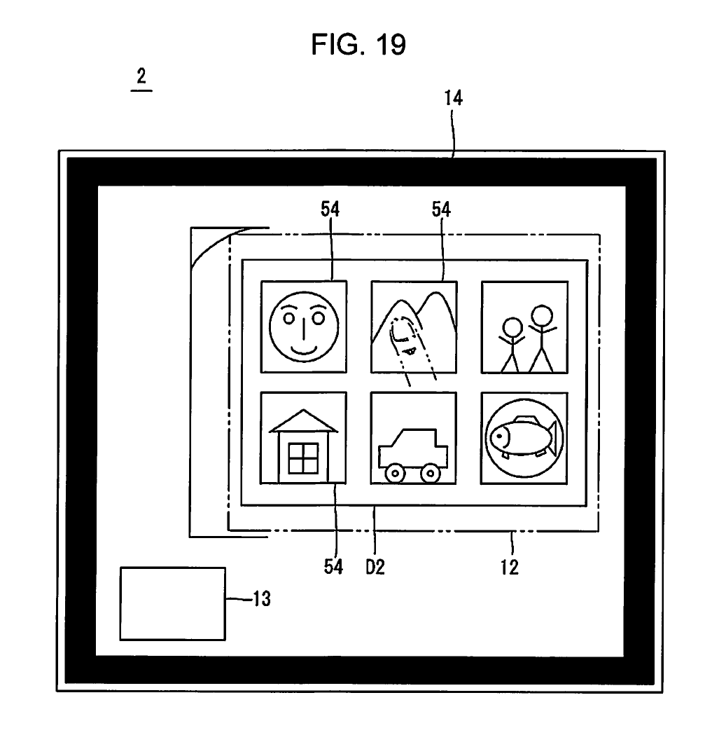

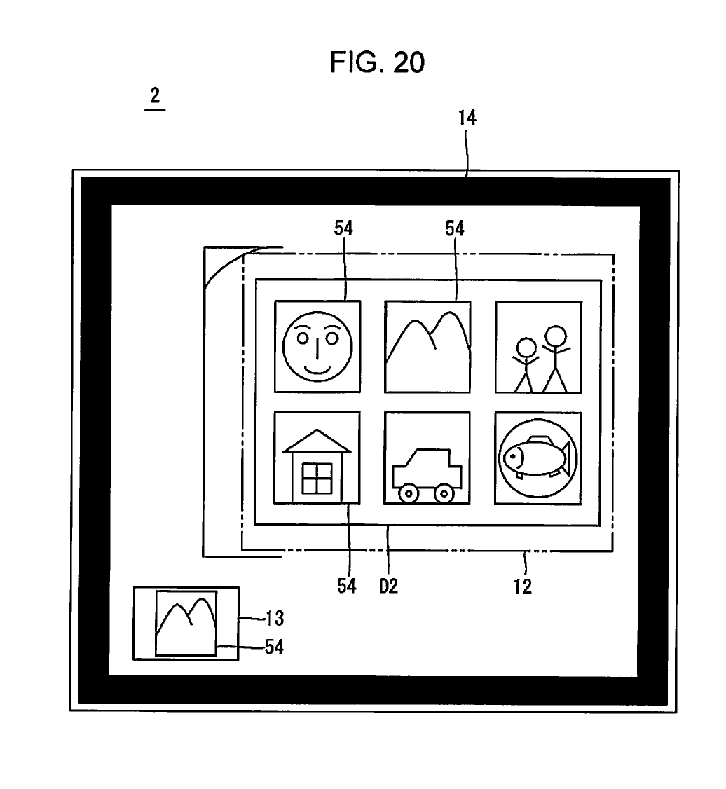

First, the user sets the print product D2 on the setting section 12 as illustrated in FIG. 18. Then, as illustrated in FIG. 19, the user performs a touch operation on the print product D2 set on the setting section 12 at a position where a desired thumbnail 54 is printed. At this time, the touch sensor 14 detects a touch position on the setting section 12 and a thumbnail 54 associated with a touch range including the detected touch position is selected. As a result, as illustrated in FIG. 20, the display 13 displays the thumbnail 54 on which the touch operation is performed.

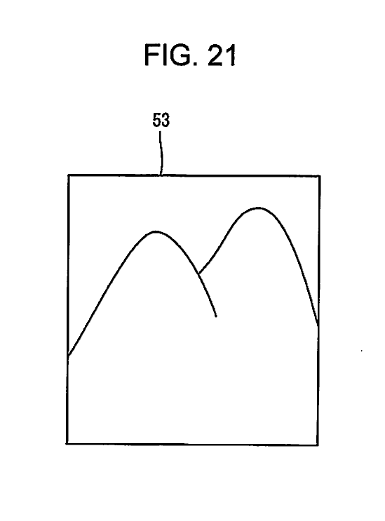

When the user views the thumbnail 54 displayed on the display 13 and performs a predetermined operation on the display 13, image data of a photograph 53 associated with the selected thumbnail 54 is transmitted from the information processing apparatus 100 to the multi-functional peripheral 2. Thus, as illustrated in FIG. 21, the photograph 53 associated with the selected thumbnail 54 is printed.

The print product D2 to be set on the setting section 12 is not limited to the print product D2 having the plurality of thumbnails 54 printed thereon in association with the plurality of photographs 53. For example, there may be used a print product D2 having a plurality of thumbnails 54 printed thereon in association with a plurality of slides to be used for a presentation or the like. In this case, a desired slide out of the plurality of slides can be printed. Further, there may be used a print product D2 having a plurality of titles printed thereon in the form of, for example, a table of contents of a written work. In this case, an area corresponding to a desired title out of the entire written work can be printed.

As described above, the multi-functional peripheral 2 of the second embodiment includes the setting section 12, the option data storing section 234, the touch sensor 14, and the option selecting section 235. The print product D2 having a plurality of options printed thereon is set on the setting section 12. The option data storing section 234 stores option data in which an option and a touch range corresponding to a print range of the option are associated with each other for each of the options on the print product D2. The touch sensor 14 detects a touch position on the setting section 12 on which the print product D2 is set. The option selecting section 235 selects an option associated with a touch range including the detected touch position on the setting section 12 in the option data.

According to this configuration, the setting section 12 on which the print product D2 is set and the touch sensor 14 are allowed to function as a touch panel. Therefore, the user can select an option by performing a touch operation on the print product D2 set on the setting section 12. Thus, it is possible to provide a multi-functional peripheral 2 excellent in operability of touch operations compared with the case where a touch operation is performed on a touch panel having a small screen size.

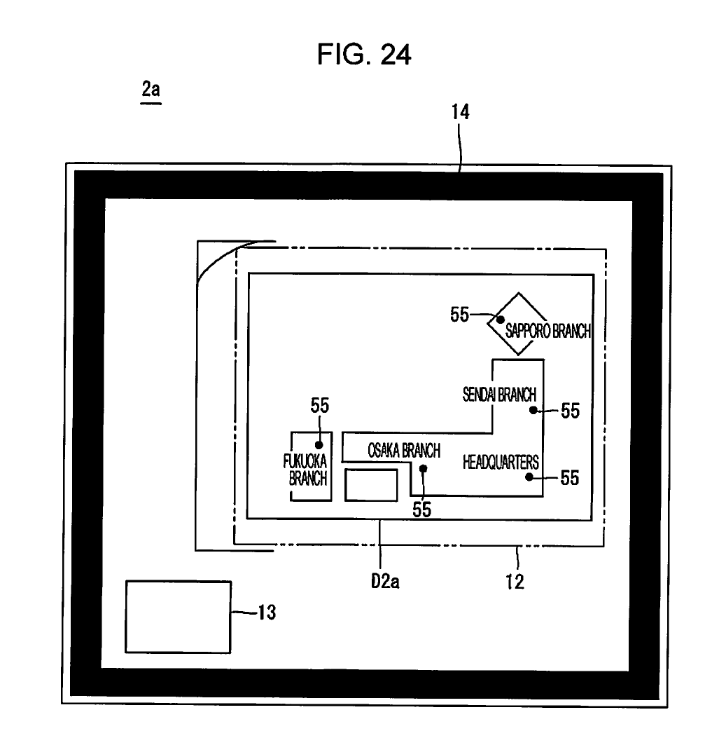

A multi-functional peripheral 2a that is a modified example of the second embodiment is described. The multi-functional peripheral 2a that is the modified example of the second embodiment is configured to execute the option selecting processing similarly to the multi-functional peripheral 2. The multi-functional peripheral 2a is configured to transmit image data based on transmission destination data associated with a selected option by using a print product D2a (see FIG. 24) having a plurality of options printed thereon in association with a plurality of pieces of transmission destination data.

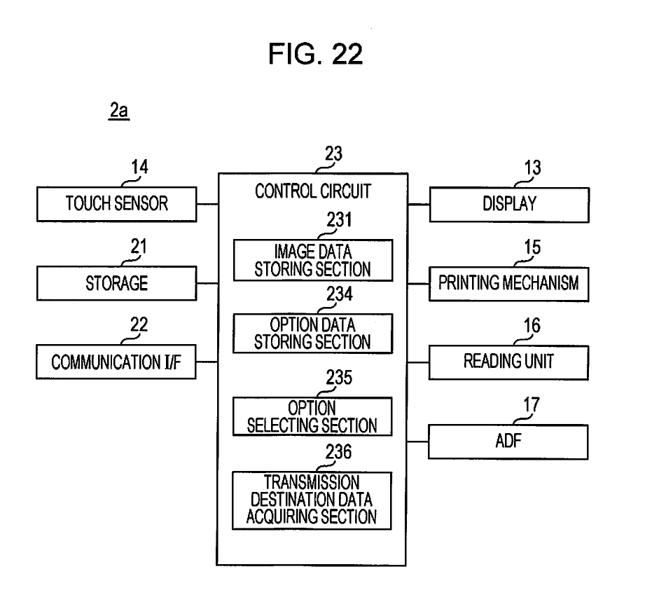

The overall configuration of the multi-functional peripheral 2a is described with reference to FIG. 22. In the multi-functional peripheral 2a, the control circuit 23 includes the image data storing section 231, the option data storing section 234, the option selecting section 235, and a transmission destination data acquiring section 236 as functional sections. The transmission destination data acquiring section 236 acquires transmission destination data associated with a selected option.

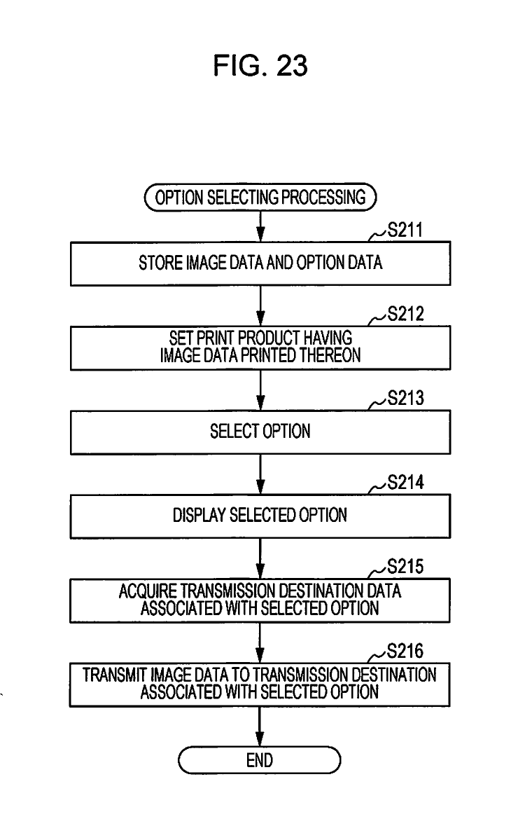

The option selecting processing to be executed by the multi-functional peripheral 2a is described with reference to FIG. 23 and also to FIG. 22.

Step S211 to Step S214 are executed similarly to Step S201 to Step S204.

In Step S215, when the user views the option displayed on the display 13 and performs a predetermined touch operation on the display 13, the transmission destination data acquiring section 236 reads out a facsimile number from the storage 21 as transmission destination data associated with the selected option and acquires the facsimile number that is thus read out.

In Step S216, the communication interface 22 transmits image data by facsimile based on the facsimile number acquired by the transmission destination data acquiring section 236, that is, the facsimile number associated with the option selected in Step S213.

In Step S215, the multi-functional peripheral 2a may request the information processing apparatus 100 to transmit transmission destination data associated with the selected option and the transmission destination data acquiring section 236 may acquire the transmission destination data transmitted from the information processing apparatus 100.

The transmission destination data is not limited to a facsimile number and may be, for example, an email address. In this case, in Step S216, the communication interface 22 transmits image data by email based on an email address associated with the selected option.

Referring to FIG. 24 to FIG. 26, an operation procedure in a case of performing facsimile transmission to a desired transmission destination by using the print product D2a having a plurality of facsimile transmission destinations 55 printed thereon is described as an example of the use of the multi-functional peripheral 2a. The print product D2a is not limited to a print product which represents the plurality of facsimile transmission destinations 55 on a map as illustrated in FIG. 24 and may be, for example, a print product which represents the plurality of facsimile transmission destinations 55 in the form of a list.

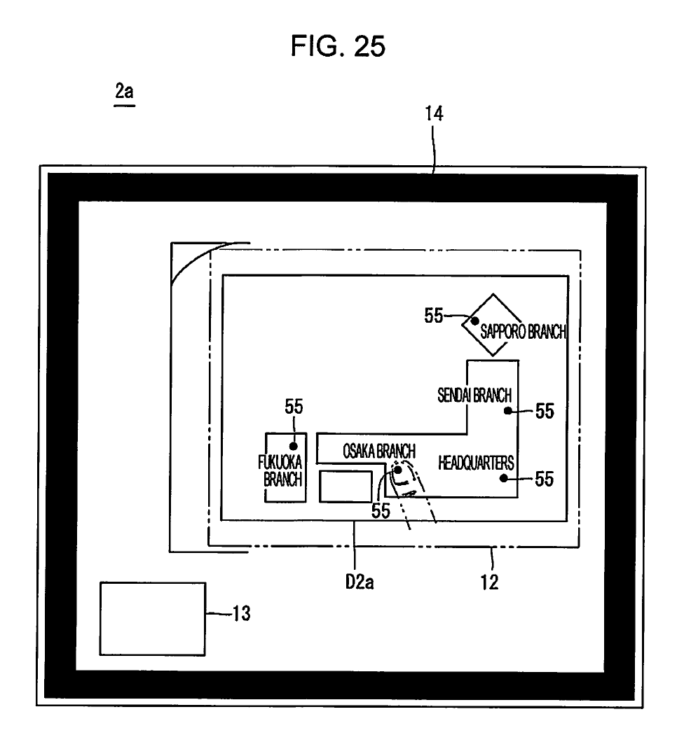

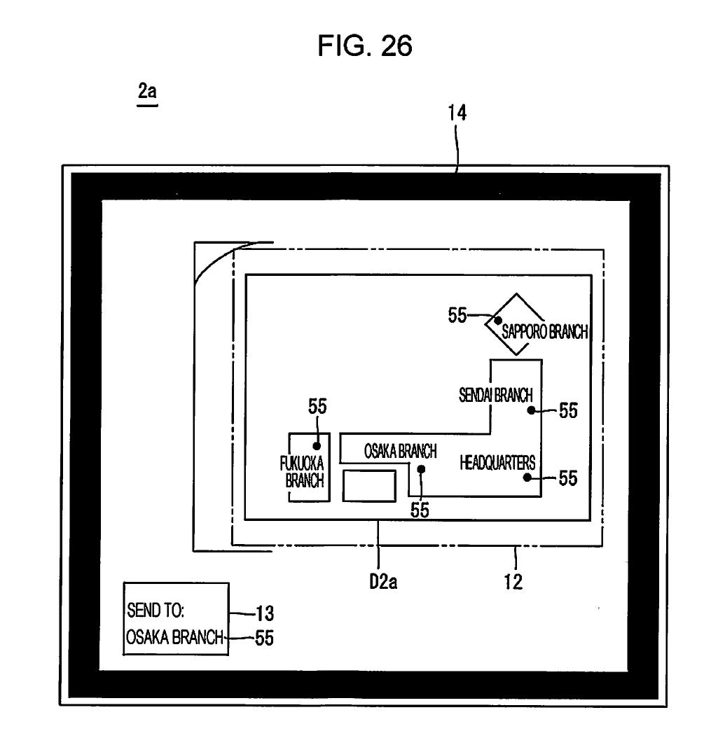

First, the user sets the print product D2a on the setting section 12 as illustrated in FIG. 24. Then, as illustrated in FIG. 25, the user performs a touch operation on the print product D2a set on the setting section 12 at a position where a desired facsimile transmission destination 55 is printed. At this time, the touch sensor 14 detects a touch position on the setting section 12 and a facsimile transmission destination 55 associated with a touch range including the detected touch position is selected. As a result, as illustrated in FIG. 26, the display 13 displays the facsimile transmission destination 55 on which the touch operation is performed. At this time, the display 13 may display the facsimile transmission destination 55 and its facsimile number.

When the user views the facsimile transmission destination 55 displayed on the display 13 and performs a predetermined operation on the display 13, a facsimile number associated with the selected facsimile transmission destination 55 is transmitted from the information processing apparatus 100 to the multi-functional peripheral 2a. Thus, image data is transmitted based on the selected facsimile transmission destination 55.

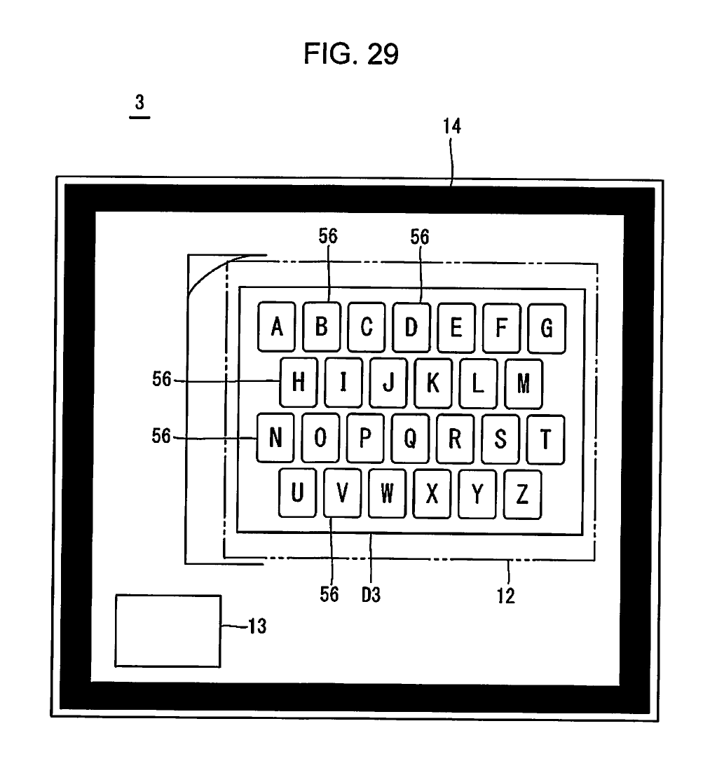

A multi-functional peripheral 3 that is an electronic apparatus according to the third embodiment of the invention is described. The multi-functional peripheral 3 of the third embodiment is configured to execute operation control processing that involves detecting a touch position on the setting section 12 on which a print product D3 (see FIG. 29) having a plurality of operation targets printed thereon is set and performing a control operation associated with an operation target based on the detected touch position.

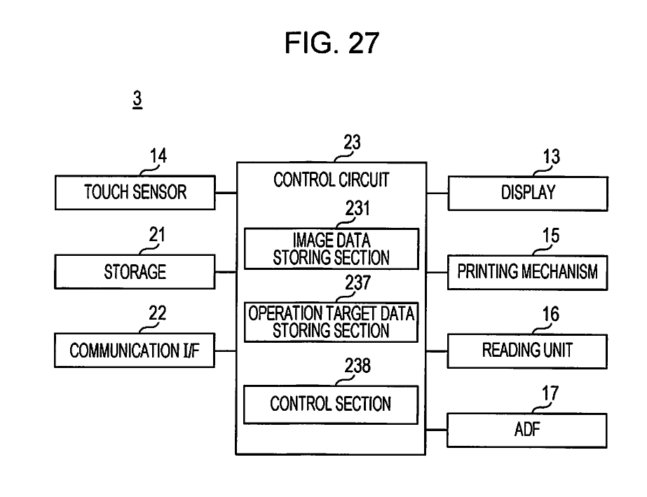

The overall configuration of the multi-functional peripheral 3 is described with reference to FIG. 27. In the multi-functional peripheral 3, the control circuit 23 includes the image data storing section 231, an operation target data storing section 237, and a control section 238 as functional sections.

The operation target data storing section 237 stores operation target data. The operation target data refers to data in which a control operation and a touch range corresponding to a print range of an operation target are associated with each other for each of the plurality of operation targets printed on the print product D3.

The control section 238 performs a control operation associated with a touch range including a detected touch position on the setting section 12 in the operation target data.

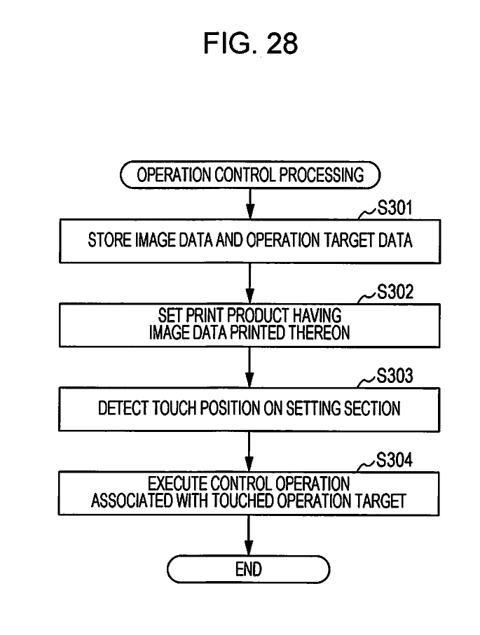

The operation control processing to be executed by the multi-functional peripheral 3 is described with reference to FIG. 28 and also to FIG. 27.

In Step S301, the information processing apparatus 100 transmits image data and operation target data associated with the print product D3 to the multi-functional peripheral 3 and the multi-functional peripheral 3 receives the image data and the operation target data. The image data and the operation target data are created by a dedicated application program in the information processing apparatus 100. The image data storing section 231 stores the image data and the operation target data storing section 237 stores the operation target data. Then, the printing mechanism 15 performs printing based on the image data, thereby creating the print product D3 having a plurality of operation targets printed thereon.

In Step S302, the user sets the print product D3 printed in Step S301 on the setting section 12.

In Step S303, when the user performs a touch operation on the print product D3 set on the setting section 12 at a desired operation target out of the plurality of operation targets, the touch sensor 14 detects a touch position on the setting section 12 on which the print product D3 is set.

In Step S304, the control section 238 refers to the operation target data stored in the operation target data storing section 237 and performs a control operation associated with a touch range including the detected touch position on the setting section 12 in the operation target data. Thus, the control section 238 executes the control operation associated with the operation target on which the touch operation is performed out of the plurality of operation targets printed on the print product D3.

As described above, by using the image data and the operation target data that are created by the dedicated application program, the user can use, as their specific user interface, the print product D3 that is printed based on the image data. For example, a print product D3 included with the multi-functional peripheral 3 may be used instead of printing the print product D3 based on the image data created by the dedicated application program. Further, operation target data stored in the storage 21 or the like in advance may be used instead of the operation target data created by the dedicated application program.

In Step S301, the multi-functional peripheral 3 may detect the type of print product D3 set on the setting section 12 and request the information processing apparatus 100 to transmit operation target data associated with the type of print product D3. Further, the multi-functional peripheral 3 may read out operation target data associated with the type of print product D3 from among a plurality of pieces of operation target data stored in the storage 21 in advance and the operation target data storing section 237 may store the operation target data. The multi-functional peripheral 3 detects the type of print product D3 based on, for example, an ID input through a touch operation on the display 13 or the like and defined for each type of print product D3 or an ID read out from a storage element (for example, an RF tag) provided on the print product D3.

Referring to FIG. 29 to FIG. 31, an operation procedure in a case of inputting a desired character or the like by using the print product D3 having a plurality of keys 56 printed thereon as operation targets is described as an example of the use of the multi-functional peripheral 3. The layout of the keys 56 on the print product D3 is not limited to general layouts (for example, a QWERTY layout) and a user's favorite layout may be used as illustrated in FIG. 29. Further, the language of the keys 56 is not particularly limited.

When the operation target is the key 56, an operation in which a character code associated with each key 56 is stored in a text memory provided in the control circuit 23 and the display 13 is controlled to display an image associated with the key 56 is defined in operation target data as a control operation.

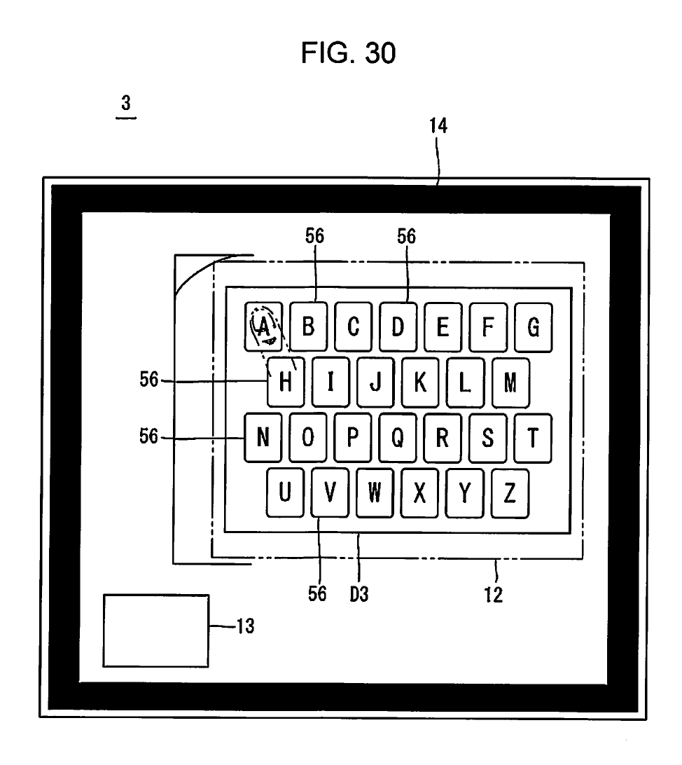

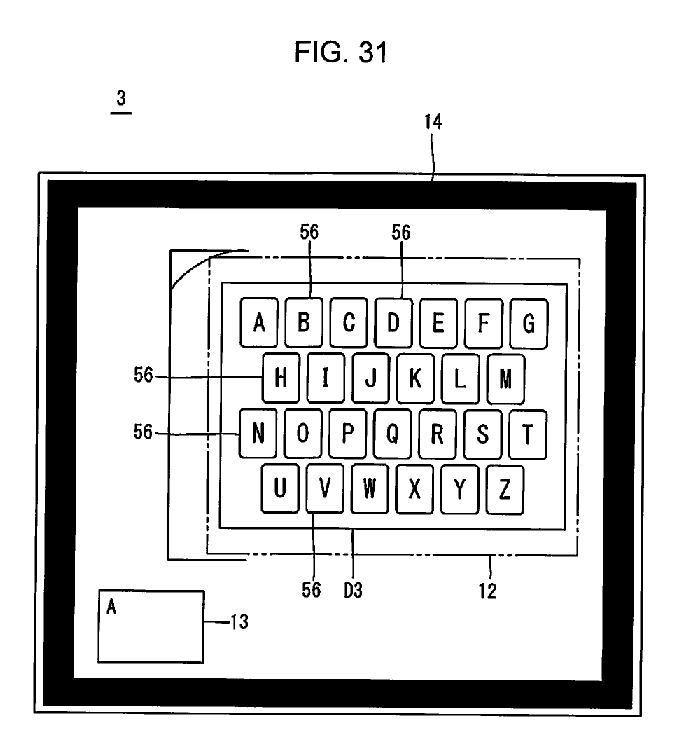

First, the user sets the print product D3 on the setting section 12 as illustrated in FIG. 29. Then, as illustrated in FIG. 30, the user performs a touch operation on the print product D3 set on the setting section 12 at a position where a desired key 56 (for example, a key 56 of “A”) is printed. At this time, the touch sensor 14 detects a touch position on the setting section 12 and a control operation associated with a touch range including the detected touch position is performed. Specifically, the control section 238 causes the text memory provided in the control circuit 23 to store a character code of “A”. Further, the control section 238 controls the display 13 to display an image associated with the key 56 of “A”. As a result, as illustrated in FIG. 31, the display 13 displays the image associated with the key 56 of “A” on which the touch operation is performed.

When the print product D3 having the plurality of keys 56 printed thereon as the operation targets is used as described above, the multi-functional peripheral 3 may read the print product D3 by the reading unit 16 and create operation target data by performing character recognition processing on the read image data.

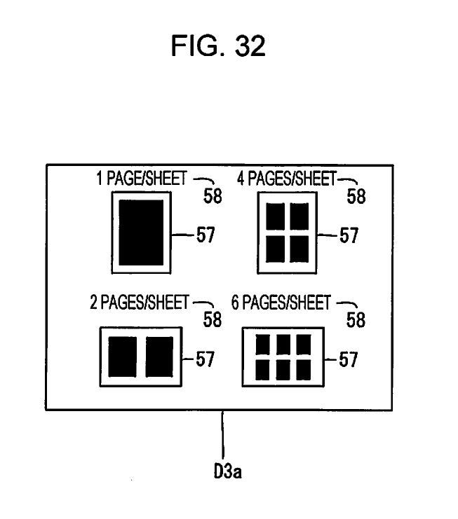

The operation target is not limited to the key 56 and may be, for example, an icon 57 for designating a printing method as in a print product D3a illustrated in FIG. 32. As illustrated in FIG. 32, a description 58 of the icon 57 can be put on the print product D3a together with the icon 57 because there is less limitation on a display space unlike the case of a touch panel having a small screen size. When the operation target is the icon 57 for designating a printing method, an operation in which the printing mechanism 15 is controlled to execute a printing method associated with each icon 57 is defined in operation target data as a control operation.

As described above, the multi-functional peripheral 3 of the third embodiment includes the setting section 12, the operation target data storing section 237, the touch sensor 14, and the control section 238. The print product D3 having a plurality of operation targets printed thereon is set on the setting section 12. The operation target data storing section 237 stores operation target data in which a control operation and a touch range corresponding to a print range of an operation target are associated with each other for each of the operation targets on the print product D3. The touch sensor 14 detects a touch position on the setting section 12 on which the print product D3 is set. The control section 238 performs a control operation associated with a touch range including the detected touch position on the setting section 12 in the operation target data.

According to this configuration, the setting section 12 on which the print product D3 is set and the touch sensor 14 are allowed to function as a touch panel. Therefore, the user can cause the multi-functional peripheral 3 to perform a desired control operation by performing a touch operation on the print product D3 set on the setting section 12. Thus, it is possible to provide a multi-functional peripheral 3 excellent in operability of touch operations compared with the case where a touch operation is performed on a touch panel having a small screen size. Further, the user's degree of freedom in terms of changing of operation targets is higher than that in a configuration in which operation targets are printed in advance on the surface of the casing 11 which is located in the detectable region of the touch sensor 14. Thus, it is also possible to reduce the manufacturing cost.

The display 13 is an example of a “display section”. The touch sensor 14 is an example of a “detection section”. The printing mechanism 15 is an example of a “printing section”. The reading unit 16 is an example of a “reading section”. The ADF 17 is an example of a “transport section”. The communication interface 22 is an example of an “image data transmitting section”.

As a matter of course, the invention is not limited to the embodiments described above and various configurations may be adopted without departing from the spirit of the invention.

What is claimed is:

1. An electronic apparatus, comprising:
a detection section that detects a touch position on an original document; and
an image editing section that edits an image on the original document,
the electronic apparatus being configured to:
detect the touch position on the original document; and
generate an edited image by editing the image on the original document based on the detected touch position.

2. The electronic apparatus according to claim 1, further comprising a display section that displays a print image based on data of the edited image.

3. The electronic apparatus according to claim 2, wherein the detection section detects a touch position in a region ranging from a region of the set original document to a region of the display section.

4. The electronic apparatus according to claim 1, further comprising:
a reading section that reads the image from the original document and stores data of the image in an image data storing section; and
an acquisition section that acquires the data of the read image from the image data storing section.

5. The electronic apparatus according to claim 4, further comprising a transport section that transports the original document to a reading position of the reading section and then transports the read original document to a setting section.

6. The electronic apparatus according to claim 1, wherein the detection section detects a touch position on the original document set on a setting section provided with a reference mark indicating a setting position of the original document.

7. The electronic apparatus according to claim 1, wherein the detection section is an optical touch sensor.

8. The electronic apparatus according to claim 1, further comprising a printing section that performs printing based on data of the edited image.

9. The electronic apparatus according to claim 1, further comprising an image data transmitting section that transmits data of the edited image.

10. The electronic apparatus according to claim 1, further comprising a casing including a main body section and an operation section provided with a region where the original document is set and with the detection section,
wherein the operation section is detachable from the main body section.

11. An electronic apparatus, comprising:
a casing having a touch surface oriented upward;
a detection section that detects a touch position on the touch surface based on whether an optical path of light passing over the touch surface is blocked; and
a processing section that performs processing based on the detected touch position.

12. An edited image producing method, comprising:
detecting a touch position on an original document; and
generating an edited image by editing an image on the original document based on the detected touch position.
